(19) United States
(12) Patent Application Publication
(10) Pub. No.: US 2002/0097188 A1
(43) Pub. Date: Jul. 25, 2002

(54) Electromagnetic radiation shielded headset and method

(76) Inventor: Scott Coloney, Tompkins Cove, NY (US)

Correspondence Address: Duane Morris LLP, 1667 K Street NW, Suite 700, Washington, DC, 20006, US

(21) Appl. No.: 09/765,273

(22) Filed: Jan. 22, 2001

(51) Int. Cl. H01Q 1/52

(52) U.S. Cl. 343/841

(57) ABSTRACT

An electromagnetic shielded speaker for a hand held radio communications device and a method for reducing exposure to electromagnetic radiation experienced by the users of such devices.

### BACKGROUND OF THE INVENTION

The present application relates to an electromagnetic shield for the earpiece of a hands-free cellular phone.

Health risks incurred by exposing the human brain to electromagnetic (EM) radiation are well known. An antenna of a cellular phone is a known EM radiation emitter, and various systems exist to protect users from exposure to EM radiation emitted from the antennae of cellular phones.

One known method for reducing the exposure of users of cellular phones to EM radiation is the use of an EM shield around the antenna. For example, the Luxon et al. U.S. Pat. No. 6,095,820 dated Aug. 1, 2000, the Bickert U.S. Pat. No. 5,907,307 dated May 25, 1999, and the Schwanke U.S. Pat. No. 5,657,386 dated Aug. 12, 1997 all disclose EM shielding devices for the antenna of a cellular phone.

A second known method for reducing the exposure of users of cellular phones is to distance the antenna of the phone from the user's head when the phone is in use. For example, the Crowley et al. U.S. Pat. No. 6,112,106 dated Aug. 29, 2000 encloses the phone with its antenna in a docking compartment remote from the user and additionally provides an EM shield for the docking compartment. Distancing the telephone from the user requires either a speaker phone or a headset. Since the use of speaker phones destroys the privacy of the conversation and may annoy others in the vicinity, a headset is often preferred.

A headset, i.e., a device which includes a speaker designed to be worn in the ear cavity of or adjacent to the ear while the phone is in use, allows the user to carry the phone and associated antenna some distance away from the head, e.g., on a belt, and reduces the intensity of the EM radiation reaching the ear from the antenna. However, it does not eliminate the exposure of the user to the EM radiation emanating from the headset speaker and/or the electrically conducting wire connecting the speaker to the cellular phone. Moreover, locating the speaker of the headset in or immediately adjacent to the ear cavity places a source of the EM radiation in the place that allows maximum EM radiation exposure to the brain.

It is accordingly an object of the present invention to provide a novel method and apparatus for reducing the potential injury from EM radiation to the user of a radio communications device by placing an EM radiation shield in the ear of a user of a radio frequency communications device, thereby shielding the user from the EM radiation emitted from the device's antenna, the device itself, and the device's remote speaker.

Another object of the present invention is provide a novel EM shielded speaker for a radio communications device.

Another object of the present application is to provide a method of minimizing a cellular phone user's exposure to EM radiation emitted from a hands-free cellular phone speaker.

These and many other objects and advantages will be apparent to one of skill in this art upon consideration of the detailed description and appended drawing.

### BRIEF DESCRIPTION OF THE DRAWINGS

FIG. 1 shows an EM shielded headset connected to a radio-frequency communications device.

FIG. 2 shows an EM shielded speaker held adjacent to an ear by a conventional holder.

FIG. 3 shows an EM shielded speaker supported by the auricle of a user's ear supported directly in the ear canal.

### DESCRIPTION OF THE PREFERRED EMBODIMENTS

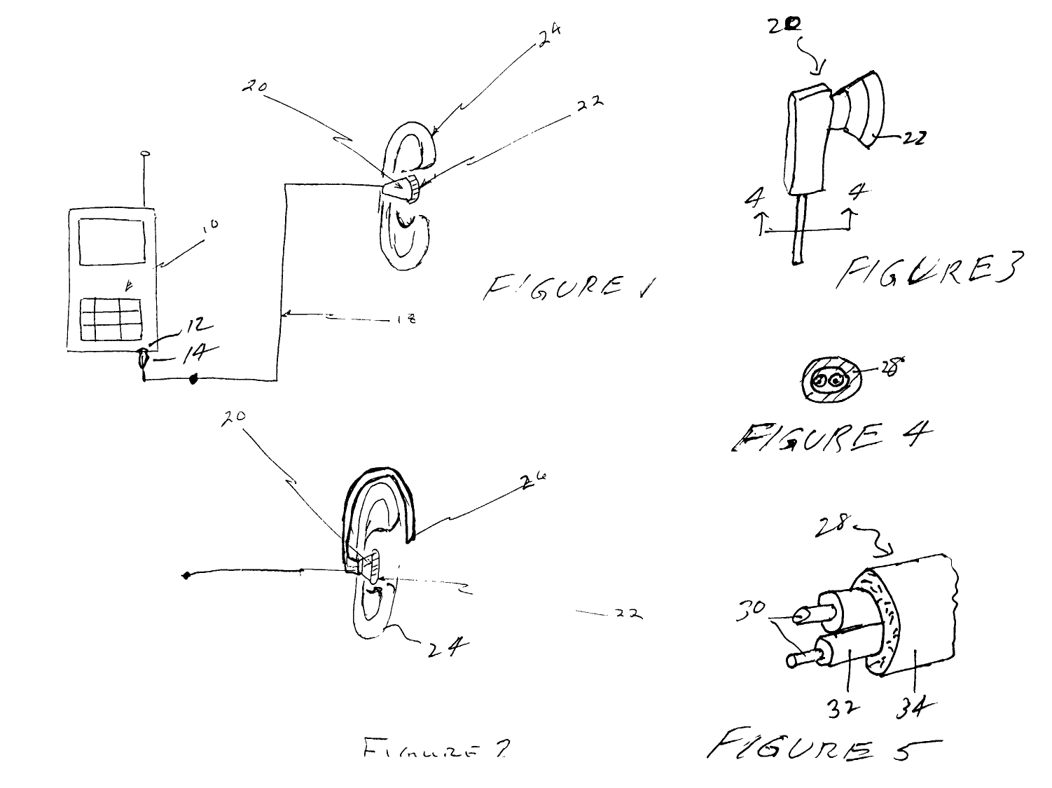

With reference to FIG. 1, a conventional hand held radio communications device 10 such as a cellular telephone is typically provided with an outlet receptacle 12 adapted to receive the jack 14 of a headset 16 which comprises an elongated electrical cable 18 and a speaker 20. The speaker 20 may be of any suitable configuration adapted to be placed into the ear cavity or held adjacent the ear by any suitable conventional means in contact with the head and/or ear of the user of the device.

The speaker 20 is covered by any suitable conventional EM radiation shielding material such as a metallic fabric or screen 22. The fabric is desirably flexible and soft to the touch so as not to irritate the ear, and may comprise a woven or pressed fabric or mesh made from one or a combination of electrically conducting fibers such as carbon, lead, potassium, steel, or copper. The shield may be attached to the speaker in any suitable conventional way, e.g., permanently adhered by gluing or removably attached to the speaker by a peripheral elastic band or the like to facilitate removal for cleaning.

Because of its position immediately adjacent the ear, the material provides a shield for the ear of the user from the EM radiation from the antenna, the electrical circuits within the body of the communications device, the electrical connector, and the speaker itself.

In one embodiment of the invention, shown in FIG. 2, the speaker 20 is worn in the ear of the user, supported by the auricle 24 of the user's ear. The communications device 10 is worn in a position away from the user's ear while the device is in use; e.g., on a user's belt. The electromagnetic shield, attached to the speaker, shields the ear from the radiation emitted from the device 10, the electrical cable 18, and the speaker 20.

In a further embodiment of the invention, shown in FIG. 3, the speaker 20 is supported adjacent to the user's ear by a conventional holder 26, such as an ear hook. Just as in the previous embodiment, the communications device 10 is worn in a position away from the user's ear while the device is in use. The shield, attached to the speaker, shields the ear from the radiation emitted from the device 10, the electrical cable 18, and the speaker 20.

While preferred embodiments of the present invention have been described, the embodiments described are illustrative only. The scope of the invention is to be defined solely by the appended claims when accorded a full range of equivalents, many variations and modifications naturally occurring to those of skill in the art from a perusal hereof.

What is claimed is:

1. In a headset for a hand held radio communications device having a speaker adapted to be worn adjacent to the ear of a user and a wire for providing an operative attachment to the communication device, the improvement wherein the speaker is covered with an electromagnetic radiation shield to thereby shield the ear of a user from electromagnetic radiation.

2. The headset of claim 1, wherein said electromagnetic shield includes fibers chosen from at least one of the group consisting of carbon, lead, copper, steel, and potassium.

3. The headset of claim 1, wherein said electromagnetic shield is a woven fabric.

4. The headset of claim 1, wherein said electromagnetic shield is permanently adhered to said speaker.

5. The headset of claim 1, wherein said electromagnetic shield is removably attached to said speaker.

6. The headset of claim 1, wherein the speaker is configured to be worn inside the ear canal of the user of the communications device.

7. The headset of claim 1, including a support configured to contact the human head to thereby support the speaker outside of the ear canal but adjacent the ear of the user of the communications device.

8. A speaker for a hand held radio communications device, said speaker being adapted to be retained by the head of the user in a position adjacent the ear and including an electromagnetic shield covering said speaker.

9. The speaker of claim 8, wherein said electromagnetic shield includes fibers chosen from at least one of the group consisting of carbon, lead, copper, steel, and potassium.

10. The speaker of claim 8, wherein said electromagnetic shield is permanently adhered to said speaker.

11. The speaker of claim 8, wherein said electromagnetic shield is removably attached to said audio output speaker.

12. In a hands-free radio frequency communications device, comprising a radio-frequency telephone and a speaker detachably connected to the device by an electronic cable , the improvement wherein the speaker is covered with an electromagnetic radiation shield, thereby reducing the electromagnetic radiation received by the ear of the user.

13. The speaker of claim 12, wherein said electromagnetic shield includes fibers chosen from at least one of the group consisting of carbon, lead, copper, steel, and potassium.

14. The speaker of claim 12, where the electromagnetic shield is permanently adhered to said audio output speaker.

15. The speaker of claim 12, where the electromagnetic shield is removably attached to said audio output speaker.

16. The speaker of claim 12, where the speaker is carried inside the ear of the user when the communications device is in use, thereby physically separating the device from the ear and providing an electromagnetic radiation shield in the ear for any radiation emanating from the cable, the device, or said speaker.

17. A method of reducing the electromagnetic radiation received by an ear of a user of a radio communications device with an antenna attached to the device, comprising the steps of:
(a) detaching the speaker from the device to which the antenna is attached;
(b) carrying the device on a part of a user's body located remotely from the ear when the device is in use;
(c) electrically connecting the audio output of the device to said speaker;
(d) covering said speaker with electromagnetic radiation shielding material; and
(e) carrying the speaker adjacent to the user's ear while the device is in use.

18. The method of claim 17, where said speaker is supported in the auricle of the user's ear.
